(19) United States
(12) Patent Application Publication
(10) Pub. No.: US 2026/0310996 A1
(43) Pub. Date: Oct. 8, 2026

(54) CROSS-PLATFORM DEVICE-LINKAGE METHOD AND APPARATUS, ELECTRONIC DEVICE, AND STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Xiao CHU, Beijing (CN); Junjie ZHAO, Beijing (CN); Zhuohua LIU, Beijing (CN); Gao JI, Beijing (CN); Xinyin WU, Beijing (CN); Honglei ZHANG, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/996,825

(22) PCT Filed: Mar. 28, 2024
(86) PCT No.: PCT/CN2024/084255

§ 371 Date: Jan. 17, 2025

(30) Foreign Application Priority Data
Apr. 3, 2023 (CN) 202310343718.X

(51) Int. Cl. G06N 5/025

(52) U.S. Cl. CPC G06N 5/025

(57) ABSTRACT

A cross-platform device-linkage method and apparatus, an electronic device, and a storage medium are provided. The method comprises: receiving, from first distributed end, first rule engine is used for instructing to execute a first action when a first trigger condition is met; receiving, from second distributed end, second rule engine used for instructing to execute a second action when a second trigger condition is met; determining, according to the first and second rule engines, third rule engine used for instructing to execute the second action when the first trigger condition is met. A central control end is provided herein, different distributed ends send rule engines for inter-device linkage to the central control end which fuses the rule engines from distributed ends, to form a rule engine for inter-device linkage of different distributed ends, so as to realize inter-device linkage of different distributed ends.

### CROSS-REFERENCE TO RELATED APPLICATIONS

This application is the U.S. national phase of PCT Application No. PCT/CN2024/084255 filed on Mar. 28, 2024, which claims priority to Chinese Patent Application No. 202310343718.X filed on Apr. 3, 202, which are incorporated herein by reference in their entireties.

### TECHNICAL FIELD

Embodiments of the present disclosure relate to the technical field of Internet of Things, and in particular, to a cross-platform device-linkage method and a cross-platform device-linkage method apparatus, an electronic device, and a storage medium.

### BACKGROUND

As shown in FIG. 1, in a home environment, a user may purchase devices of a plurality of vendors, and a plurality of devices currently belonging to the same vendor platform may be linked. For example, in FIG. 1, the user may control a smart speaker of a vendor A through voice, so that the smart speaker is linked with an air conditioner of the vendor A, thereby controlling the air conditioner to be turned on or off. However, devices under different vendor platforms cannot find each other, so that linkage between devices of different vendors cannot be realized.

### SUMMARY

In a first aspect, a cross-platform device-linkage method is provided in the embodiments of the present disclosure. The method includes: receiving a first rule engine from a first distributed end, wherein the first rule engine is configured to indicate that a first action is performed in a case that a first trigger condition is met; receiving a second rule engine from a second distributed end, wherein the second rule engine is configured to indicate that a second action is performed in a case that a second trigger condition is met; determining a third rule engine according to the first rule engine and the second rule engine, wherein the third rule engine is configured to indicate that the second action is performed in a case that the first trigger condition is met.

Optionally, determining the third rule engine according to the first rule engine and the second rule engine further includes: receiving first data corresponding to the first trigger condition from the first distributed end; determining whether the first data satisfies the first trigger condition; if satisfying, then triggering the second distributed end to perform the second action.

Optionally, the first rule engine includes a first dependency condition, and the second rule engine includes a second dependency condition; determining the third rule engine according to the first rule engine and the second rule engine includes: determining whether the first dependency condition matches the second dependency condition; and if matching, then fusing the first rule engine and the second rule engine to form the third rule engine.

Optionally, determining the third rule engine according to the first rule engine and the second rule engine includes: if an identifier corresponding to the first trigger condition is definite and an identifier corresponding to the second trigger condition is indefinite, using the first trigger condition of the third rule engine; if the identifier corresponding to the first action is indefinite and the identifier corresponding to the second action is definite, using the second action for the third rule engine.

Optionally, the first dependency condition includes at least one of following: a user identifier, location information, and time information; the second dependency condition includes at least one of following: a user identifier, location information, and time information.

Optionally, before receiving the first data corresponding to the first trigger condition from the first distributed end, the method further includes: sending, to the first distributed end, a subscription request for subscribing to the first data.

Optionally, triggering the second distributed end to perform the second action includes: sending, to the second distributed end, a control request for performing the second action; or sending the first data to the second distributed end, to trigger the second distributed end to perform the second action according to the second rule engine.

Optionally, the method further includes: generating a fourth rule engine according to input information of a user on a user interface, wherein the fourth rule engine is used to indicate that the first action is performed when the second trigger condition is met, wherein an identifier corresponding to the second trigger condition is indefinite and an identifier corresponding to the first action is indefinite; sending the fourth rule engine to the first distributed end and the second distributed end, so that the first distributed end determines the first rule engine according to the fourth rule engine, and the second distributed end determines the second rule engine according to the fourth rule engine.

Optionally, triggering the second distributed end to perform the second action further includes: determining whether a fifth rule engine related to the third rule engine exists, wherein the fifth rule engine is used to indicate that a third action is triggered when a third trigger condition is met; determining priorities of the third rule engine and the fifth rule engine if the fifth rule engine exists and the third trigger condition is met; when the priority of the third rule engine is higher than the priority of the fifth rule engine, triggering the second distributed end to perform the second action.

In a second aspect, a cross-platform device-linkage method is provided. The method includes: sending a first rule engine to a central control end, wherein the first rule engine is used to indicate that a first action is performed when a first trigger condition is met.

Optionally, an identifier corresponding to the first trigger condition is definite and an identifier corresponding to the first action is indefinite.

Optionally, the method further includes sending first data corresponding to the first trigger condition to the central control end.

Optionally, the first rule engine further includes a first dependency condition, wherein the first dependency condition is used by the central control end to determine whether the first rule engine matches another rule engine.

Optionally, the first dependency condition includes at least one of following: a user identifier, location information, and time information.

Optionally, before sending the first rule engine to the central control end, the method further includes: receiving a fourth rule engine from the central control end, wherein the fourth rule engine is used to indicates that the first action is performed when a second trigger condition is met, wherein an identifier of a resource corresponding to the second trigger condition is indefinite, and an identifier of a resource corresponding to the first action is indefinite; determining the first rule engine according to the fourth rule engine.

Optionally, before the sending the first rule engine to the central control end, the method further includes: generating the first rule engine according to input information of a user on a user interface.

In a third aspect, a cross-platform device-linkage method is provided. The method includes: sending a second rule engine to a central control end, wherein the second rule engine is configured to indicate that a second action is performed when a second trigger condition is met.

Optionally, an identifier of a resource corresponding to the second trigger condition is indefinite and an identifier of a resource corresponding to the second action is definite.

Optionally, the second rule engine further includes a second dependency condition, wherein the second dependency condition is used by the central control end to determine whether the second rule engine matches another rule engine.

Optionally, the second dependency condition includes at least one of following: a user identifier, location information, and time information.

Optionally, before sending the second rule engine to the central control end, the method further includes: receive a fourth rule engine from the central control end, wherein the fourth rule engine is configured to indicate that a first action is performed when the second trigger condition is met, wherein an identifier of a resource corresponding to the second trigger condition is indefinite, and an identifier of a resource corresponding to the first action is indefinite; determining the second rule engine according to the fourth rule engine.

Optionally, the method further includes: receiving, from the central control end, a control request configured to perform the second action; controlling, according to the control request, to perform the second action; or, receiving first data from the central control end; controlling, according to the second rule engine, to perform the second action when the first data meets a second trigger condition.

Optionally, before the sending the first rule engine to the central control end, the method further includes: generating the second rule engine according to input information of a user on a user interface.

In a fourth aspect, a cross-platform device-linkage device is provided. The device includes: a first receiving module, configured to receive a first rule engine from a first distributed end, wherein the first rule engine is configured to indicate that a first action is performed in a case that a first trigger condition is met; a second receiving module, configured to receive a second rule engine from a second distributed end, wherein the second rule engine is configured to indicate that a second action is performed in a case that a second trigger condition is met; a fusion module, configured to determine a third rule engine according to the first rule engine and the second rule engine, wherein the third rule engine is used to indicate that the second action is performed when the first trigger condition is met.

In a fifth aspect, a cross-platform device-linkage device is provided. The device includes a first sending module, configured to send a first rule engine to a central control end, wherein the first rule engine is configured to indicate that a first action is performed in a case that a first trigger condition is met.

In a sixth aspect, a cross-platform device-linkage device is provided. The device includes a first sending module, configured to send a second rule engine to a central control end, wherein the second rule engine is used to indicate that a second action is performed when a second trigger condition is met.

In a seventh aspect, an electronic device is provided. The device includes: a processor, a memory, and a program stored in the memory and executable on the processor, wherein when the program is executed by the processor, the processor implements steps of the cross-platform device-linkage method according to the above first aspect, or steps of the cross-platform device-linkage method according to the above second aspect, or steps of the cross-platform device-linkage method according to the above third aspect.

In an eighth aspect, a computer-readable storage medium is provided, wherein a computer program is stored on the computer-readable storage medium, wherein when the computer program is executed by a processor, the processor implements steps of the cross-platform device-linkage method according to the above first aspect, or steps of the cross-platform device-linkage method according to the above second aspect, or steps of the cross-platform device-linkage method according to the above third aspect.

### BRIEF DESCRIPTION OF THE DRAWINGS

Various other advantages and benefits will become apparent to those of ordinary skill in the art by reading the following detailed description of the preferred embodiments. The drawings are for the purpose of illustrating the preferred embodiments only and are not to be considered limiting of the invention. Moreover, in the entire drawings, the same reference symbols are used to refer to the same components. In the drawings:

FIG. 1 is a schematic diagram of a connection mode of an Internet of Things platform of Internet of Things devices in a home environment;

FIG. 2 is a schematic diagram of a rule engine implemented by resources and attributes;

FIG. 3 is a schematic diagram of an example of applying a rule engine implemented by resources and attributes;

FIG. 4 is a schematic flowchart of a cross-platform device-linkage method according to an embodiment of the present disclosure;

FIG. 5 is a schematic diagram of a rule engine according to an embodiment of the present disclosure;

FIG. 6 is a schematic flowchart of another cross-platform device-linkage method according to an embodiment of the present disclosure;

FIG. 7 is a schematic flowchart of still another cross-platform device-linkage method according to an embodiment of the present disclosure;

FIG. 8 is a schematic diagram of a cross-platform device-linkage method according to Embodiment 1 of the present disclosure;

FIG. 9 is a schematic diagram of a cross-platform device-linkage method according to Embodiment 2 of the present disclosure;

FIG. 10 is a schematic diagram of a cross-platform device-linkage method according to Embodiment 3 of the present disclosure;

FIG. 11 is a schematic diagram of a cross-platform device-linkage method according to Embodiment 4 of the present disclosure;

FIG. 12 is a schematic diagram of a cross-platform device-linkage method according to Embodiment 5 of the present disclosure;

FIG. 13 is a schematic diagram of a cross-platform device-linkage method according to Embodiment 6 of the present disclosure;

FIG. 14 is a schematic structural diagram of a cross-platform device-linkage apparatus according to an embodiment of the present disclosure;

FIG. 15 is a schematic structural diagram of another cross-platform device-linkage apparatus according to an embodiment of the present disclosure;

FIG. 16 is a schematic structural diagram of still another cross-platform device-linkage apparatus according to an embodiment of the present disclosure;

FIG. 17 is a schematic structural diagram of an electronic device according to an embodiment of the present disclosure.

### DETAILED DESCRIPTION

The technical solutions in the embodiments of the present disclosure will be clearly and completely described below with reference to the accompanying drawings in the embodiments of the present disclosure. All other embodiments obtained by a person of ordinary skill in the art based on the embodiments of the present disclosure without creative efforts shall fall within the protection scope of the present disclosure. Embodiments of the present disclosure provide a cross-platform device-linkage method and apparatus, an electronic device, and a storage medium, to resolve a problem that devices of different vendors cannot be linked.

The following first briefly describes the technical content involved in the present disclosure.

### I. Internet of Things Platform Standard

The Internet of Things platform is a core of an Internet of Things system, and functions to support an Internet of Things application and an Internet of Things device. At present, an Internet of Things platform standard having a relatively large international influence includes an oneM2M standard or the like, and the standard system includes several types of nodes: an Infrastructure Node (IN), specifically, IN may be a server and an middle node (MN), specifically, the MN may be a gateway, an edge server, and the like; and an application service node (ASN) and an application dedicated node (ADN), specifically, the ASN may be a terminal device, and the AND may be a sensing device. The infrastructure node (IN), the middle node (MN), and the application node (ASN and ADN) are composed of an application entity (AE) and/or a common service entity (CSE), and the specific AE may be an application software/module, and the CSE may be a service software/module. The relationship between the node and the entity is as follows: the ASN includes one CSE and at least one AE, the ADN includes at least one AE, the MN includes a CSE and zero or more AEs, and the IN includes one CSE and zero or more AEs.

### II. Rule Engine

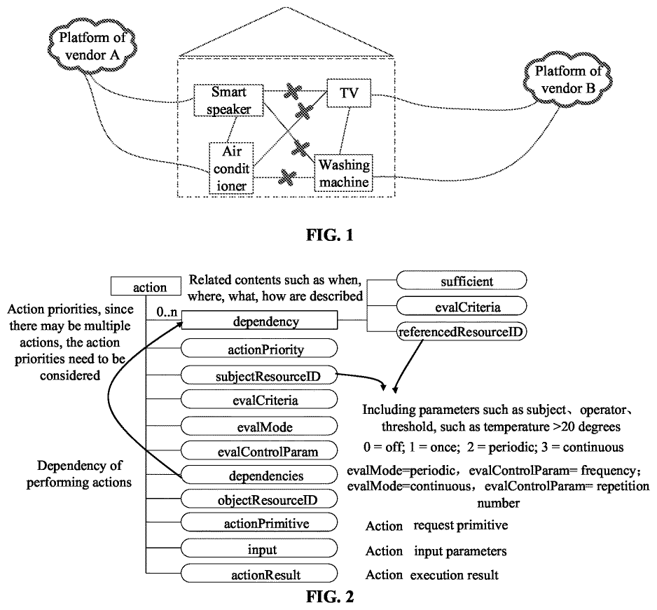

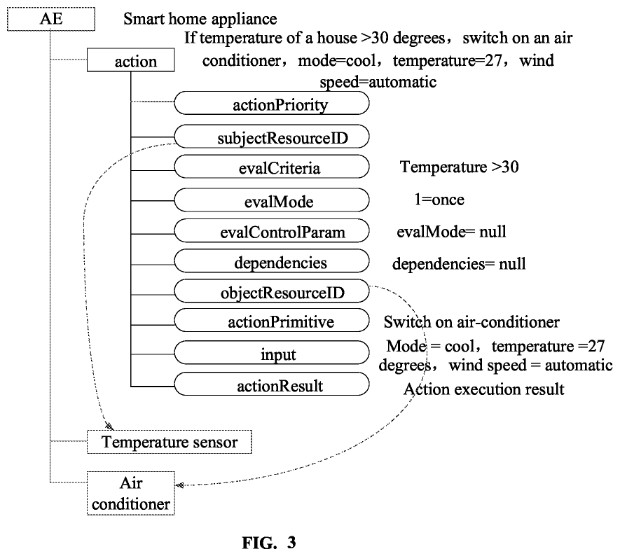

The rule engine may be implemented by resources and attributes, the resources may include sub-resources, the resources/sub-resources may include attributes, and the attributes cannot include resources. For example, the rule engine may use the <action> resource to label, the trigger condition is whether the value contained in the subject resource pointed to by the subjectResourceID satisfies the rule defined by the evalCriteria attribute, and if the rule is met, the action primitive defined by the actionPrimitive attribute is triggered to be executed for the objectResource resource pointed to by the objectResourceID, and please refer to FIG. 2 for detailed structure.

In a smart home scenario, in an example in which the air conditioner is automatically turned on according to the temperature, such as “when home temperature>30 degrees, the air conditioner is turned on, mode=cold air, temperature=27 degrees, wind speed=automatic”, and the structure of the <action> resource is shown in FIG. 3, and the specific implementation process is as follows:
1. the temperature sensor reports the temperature value to the Internet of Things platform, and records the temperature value in the temperature sensor resource pointed to by the subjectResourceID;
2 the action resource determines whether the temperature value in the temperature sensor resource pointed to by the subjectResourceID satisfies (temperature>30 degrees);
3. when the temperature>30 degrees is satisfied, the action primitive defined in the actionPrimitive is sent to the air conditioning device pointed to by the objectResourceID (turning on the air conditioner), and the input is used as the input parameter, and input is the auxiliary information of “mode=cool, temperature=27 degrees, and wind speed=automatic”;
4. receiving the execution result of executing the action primitive by the air-conditioning device and storing the execution result in the actionResult.

Scenario linkage is a visual programming mode of developing an automated service logic in a rule engine. The linkage rule between the devices is defined in a visual manner, and the rules are deployed to the cloud end or the edge end.

The scenario linkage rule consists of three parts: a Trigger, a Condition, and an Action. This rule model is referred to as a TCA model.

When an event or attribute specified by the trigger (excluding date, enum, struct, and array type) occurs, the system determines whether the execution condition is satisfied to determine whether to execute the execution action defined in the scenario linkage rule. If the condition is met, the action is executed; otherwise, it is not executed.

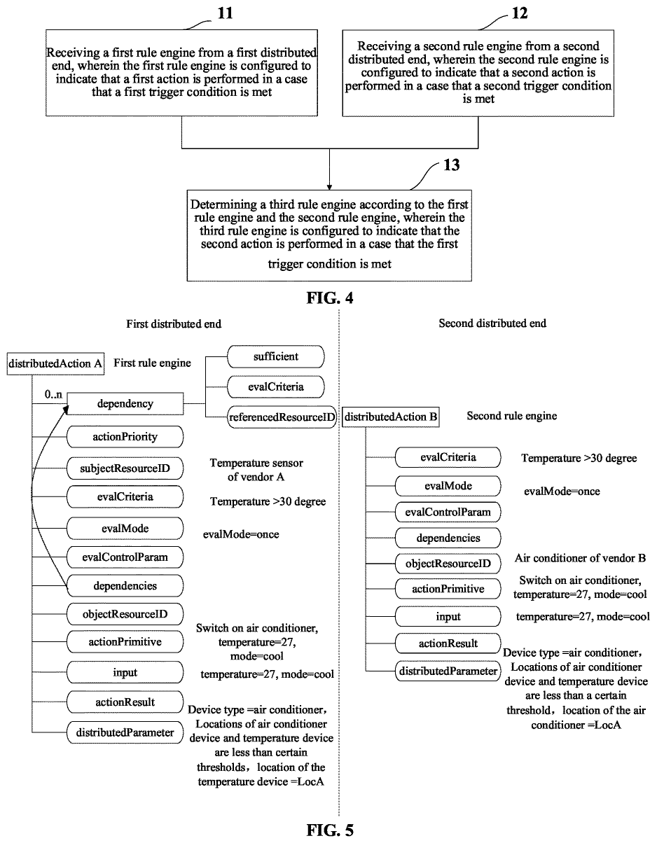

In order to solve the problem that devices of different vendors cannot be linked, referring to FIG. 4, an embodiment of the present disclosure provides a cross-platform device-linkage method, which is executed by a central control end, and the method includes:
Step 11: receive a first rule engine from a first distributed end, where the first rule engine is configured to perform a first action in a case that a first trigger condition is met; and
Step 12: receive a second rule engine from a second distributed end, where the second rule engine is used to instruct to perform a second action when a second trigger condition is met; and
Step 13: determine a third rule engine according to the first rule engine and the second rule engine, where the third rule engine is used to indicate that the second action is performed when the first trigger condition is met.

The rule engine is information about an Internet of Things platform (a first distributed end and a second distributed end) for controlling an Internet of Things device, and the rule engine includes a trigger condition (for example, a first trigger condition or a second trigger condition) and an action (for example, a first action or a second action) performed after the trigger condition is met. In a complete rule engine, the trigger condition corresponds to a trigger object (such as the subjectResourceID), and the action corresponds to an execution object (such as the objectResourceID), wherein when the first data corresponding to the trigger object meets the trigger condition, the execution object is triggered to perform the action.

In this embodiment of the present disclosure, by setting a central control end, the central control end is respectively connected to a plurality of distributed ends (vendor platforms), different distributed ends send the rule engines for inter-device linkage to the central control end, and the central control end fuses the rule engines from different distributed ends, so as to form a rule engine for inter-device linkage of different distributed ends, so as to implement linkage between devices of different distributed ends.

In this embodiment of the present disclosure, optionally, the identifier corresponding to the first trigger condition is definite and the identifier corresponding to the first action is indefinite, that is, the first rule engine is an incomplete rule engine. The identifier of the resource corresponding to the second trigger condition is indefinite and the identifier of the resource corresponding to the second action is definite, that is, the second rule engine is an incomplete rule engine.

The “fusion” means that the central control end combines two incomplete rule engines to form a new complete rule engine for realizing inter-device linkage.

In this embodiment of the present disclosure, the structure of the existing rule engine does not need to be changed, and only two incomplete rule engines need to be combined into a new complete rule engine, so that the system modification is small, and the implementation cost is low.

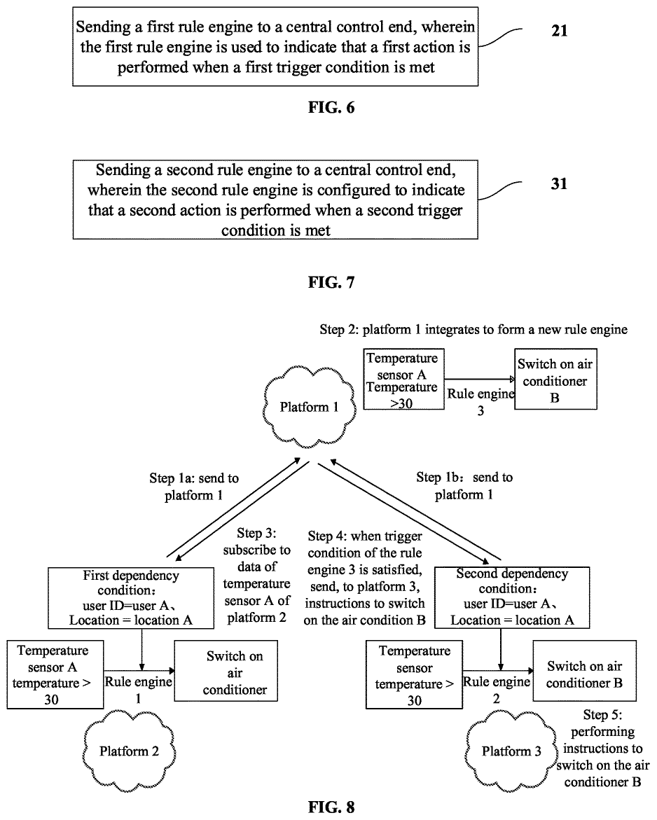

For example, referring to FIG. 5, the first rule engine of the first distributed end is that the air conditioner is turned on when the temperature is greater than 30 degrees (the first trigger condition), the mode=cool, and the temperature is 27 degrees (the first action); it is assumed that the device under the first distributed end includes a temperature sensor, but does not include an air conditioner, that is, an identifier (subjectResourceID) corresponding to a first trigger condition in the first rule engine is definite and is an identifier of a temperature sensor of the vendor A, and an identifier (objectResourceID) corresponding to the first action is indefinite and is null. In this case, since the device in the first distributed end does not have the air conditioner, the first action cannot be executed, and the first rule engine needs to be sent to the central control end.

It should be noted that, in some cases, even if the device under the first distributed end has the air conditioner, the air conditioner may not access the first distributed end (for example, the air conditioner is not powered), and at this time, the first distributed end does not search for the air conditioner, and at this time, the identifier (objectResourceID) corresponding to the first action may also be set to be indefinite, which is null.

In addition, when the rule engine is input by the user at the distributed end, the user may also determine whether to set the identifier corresponding to the trigger condition or the identifier corresponding to the action to be definite or indefinite, even if the identifier corresponding to the trigger condition or the identifier corresponding to the action exists. For example, the device under the first distributed end has an air conditioner, but the user wants to start the air conditioner at the second distributed end, and at this time, the user may set the identifier corresponding to the first action to be indefinite, which is null.

In summary, the identifier corresponding to the trigger condition or action is indefinite, including a plurality of cases, which may be that the device does not exist, or may exist in the device, but is not searched, or the device exists, but is set to be indefinite.

Referring to FIG. 5, the second rule engine of the second distributed end is: when the temperature is greater than 30 degrees (the second trigger condition), the air conditioner is turned on, the mode=cool, and the temperature is 27 degrees (the second action); it is assumed that the device under the second distributed end includes an air conditioner but does not include a temperature sensor, that is, the identifier corresponding to the second trigger condition in the second rule engine is indefinite, and is null; and an identifier (objectResourceID) corresponding to the second action is definite, and is the air conditioner of the vendor B. In this case, since the device in the second distributed end does not have the temperature sensor, it cannot be determined whether the second trigger condition is met, and the second rule engine needs to be sent to the central control end.

Similarly, the identifier corresponding to the second trigger condition in the second rule engine is indefinite, and “indefinite” herein not only includes that the device does not exist, but may also be that the device exists but is not searched, or the device exists, but is set to be indefinite.

In an embodiment of the present disclosure, the determining a third rule engine according to the first rule engine and the second rule engine includes: if the identifier corresponding to the first trigger condition is definite and the identifier corresponding to the second trigger condition is indefinite, the third rule engine uses the first trigger condition; and if the identifier corresponding to the first action is indefinite and the identifier corresponding to the second action is definite, the third rule engine uses the second action.

Still as illustrated in the example in FIG. 5, the third rule engine is: when the temperature is greater than 30 degrees (the first trigger condition), the switching on the air conditioner is executed, the mode=cool, the temperature is 27 degrees (the second action), the identifier (subjectResourceID) corresponding to the first trigger condition in the third rule engine is definite, and is the identifier corresponding to the temperature sensor of the vendor A, and the identifier (objectResourceID) corresponding to the second action is definite, and is the identifier of the air conditioner of the vendor B.

In other words, if the rule engines received by the central control end from the first distributed end and the second distributed end are incomplete rule engines (subjectResourceID or objectResourceID is missing), the incomplete two rule engines are fused into a complete rule engine, so as to realize linkage between devices of different distributed ends.

In the foregoing embodiment, whether the rule engine is complete is determined by determining whether the identifier (subjectResourceID) corresponding to the trigger condition and the identifier (objectResourceID) corresponding to the action are definite, and if the identifier (subjectResourceID) corresponding to the trigger condition and the identifier (objectResourceID) corresponding to the action are both definite, and are complete rule engines, and if one of the identifier (subjectResourceID) corresponding to the trigger condition or the identifier (objectResourceID) corresponding to the action is indefinite, the rule engine is an incomplete rule engine.

In some other embodiments of the present disclosure, the rule engine may also be changed, and the trigger condition may not correspond to an identifier (subjectResourceID), but may correspond to other trigger objects, for example, a location, for example, the first rule engine of the first distributed end is: starting the air conditioner (the first action) if the temperature of the location A is greater than 30 degrees (the first trigger condition); it is assumed that the device under the first distributed end includes a temperature sensor, and a location where the temperature sensor is located is A, that is, the trigger object (location A) corresponding to the first trigger condition in the first rule engine is definite.

Certainly, the trigger object such as the identifier and the location is merely an example, and the trigger object may not be limited thereto.

In an embodiment of the present disclosure, optionally, the first rule engine includes a first dependency condition, and the second rule engine includes a second dependency condition; and determining the third rule engine based on the first rule engine and the second rule engine includes: determining whether the first dependency condition matches the second dependency condition; and if match, then fusing the first rule engine and the second rule engine to form a third rule engine.

Optionally, the first dependency condition includes at least one of the following: a user identifier, location information, and time information; and the second dependency condition includes at least one of the following: a user identifier, location information, and time information. The location information may be location information of the user or location information of the device, and the time information may be a time range of performing an action.

The foregoing dependency conditions (the first dependency condition and the second dependency condition) are conditions for determining whether the first rule engine and the second rule engine match, and may be fused only when the two rule engines match. Otherwise, no fusion may be made.

Still as shown in the example shown in FIG. 5, in FIG. 5, the first rule engine includes a first dependency condition, where the first dependency condition is: a device type=an air conditioner, distance of locations of the air conditioning device and the temperature sensor is less than a certain threshold, a location of the temperature sensor=LocA, the second rule engine includes a second dependency condition, the second dependency condition is: a device type=an air conditioner; distance between locations of the air conditioning device and the temperature sensor is less than a certain threshold, and a location of the air conditioning device=LocA. In this case, it can be seen that the first dependency condition matches the second dependency condition, and in this case, the first rule engine and the second rule engine are fused to form a third rule engine. If the first dependency condition and the second dependency condition do not match, for example, in the first dependency condition, the location of the temperature sensor=LocA, and in the second dependency condition, the location of the air conditioning device=LocB, and the distance between the LocA and the LocB is greater than the threshold, the first dependency condition and the second dependency condition do not match, and the first rule engine and the second rule engine cannot be fused.

In this embodiment of the present disclosure, optionally, the determining the third rule engine based on the first rule engine and the second rule engine further includes: receiving first data corresponding to the first trigger condition from the first distributed end; determining whether the first data satisfies the first trigger condition; and if satisfy, triggering the second distributed end to perform the second action.

The first data is data of an identifier (subjectResourceID) corresponding to a first trigger condition.

Still illustrated by the example shown in FIG. 5, the first data is temperature data (i.e. first data) of a temperature sensor from the first distributed end, and after the central control end receives the temperature data, the central control end determines whether the temperature is greater than 30 degrees, and if greater, the second distributed end is triggered to turn on the air conditioner.

In this embodiment of the present disclosure, optionally, before receiving the first data corresponding to the first trigger condition from the first distributed end, the method further includes: sending a subscription request for subscribing to the first data to the first distributed end. Certainly, in some other embodiments of the present disclosure, optionally, the first distributed end may also actively report the first data.

In some embodiments of the present disclosure, optionally, the triggering the second distributed end to perform the second action includes: sending a control request for executing the second action to the second distributed end.

In some other embodiments of the present disclosure, optionally, the triggering the second distributed end to perform the second action includes: sending the first data to the second distributed end to trigger the second distributed end to perform the second action according to the second rule engine.

In other words, when the first data satisfies the first trigger condition, the central control end may generate a control request for triggering the second distributed end to perform the second action, or may directly send the first data to the second distributed end when the first data meets the first trigger condition, and the second distributed end executes the second action according to the second rule engine.

In this embodiment of the present disclosure, optionally, the method further includes: forming a fourth rule engine according to input information of a user on a user interface, where the fourth rule engine is used to instruct to perform the first action when the second trigger condition is met, where an identifier corresponding to the second trigger condition is indefinite and an identifier corresponding to the first action is indefinite; and sending the fourth rule engine to the first distributed end and the second distributed end, so that the first distributed end determines the first rule engine according to the fourth rule engine, and the second distributed end determines the second rule engine according to the fourth rule engine.

For example, when the user inputs, on the user interface provided by the central control end, the fourth rule engine “the temperature is greater than 30 degrees (the second trigger condition), the switching on the air conditioner is executed, the mode=cool, the temperature is 27 degrees (the first action)”, the identifier (subjectResourceID) corresponding to the second trigger condition in the fourth rule engine is indefinite and is null, and the identifier (objectResourceID) corresponding to the first action is indefinite and is null. That is, there is no identification information of the temperature sensor and the air conditioner in the fourth rule engine. In this case, the central control end broadcasts the incomplete fourth rule engine to the first distributed end and the second distributed end, and the first distributed end having the temperature sensor may generate the first rule engine according to the fourth rule engine, fill the identifier (subjectResourceID) corresponding to the second trigger condition as the identifier of the temperature sensor used as the first trigger condition, and the second distributed end having the air conditioner may generate the second rule engine according to the fourth rule engine, and fill the identifier (objectResourceID) corresponding to the first action as the identifier of the air conditioner used as the second action.

In this embodiment of the present disclosure, optionally, the triggering the second distributed end to perform the second action further includes: determining whether a fifth rule engine related to the third rule engine exists, where the fifth rule engine is used to instruct to trigger a third action when a third trigger condition is met; and determining priorities of the third rule engine and the fifth rule engine if the fifth rule engine exists and the third trigger condition is met; and triggering the second distributed end to perform the second action when the priority of the third rule engine is higher than the priority of the fifth rule engine.

That is, the central control end may have a plurality of rule engines, and the related rule engine may have a priority, and if the trigger conditions of the plurality of rule engines are all satisfied, the central control end determines which rule engine to be executed according to the priority. For example, if the third rule engine is “closing the window and turning on the air conditioner when the temperature is greater than 30 degrees”, the fifth rule engine is that “the carbon monoxide detector detects that the carbon monoxide is greater than 200 ppm, opening the window”, the priority of the third rule engine is lower than the priority of the fifth rule engine, and in this case, if both the trigger conditions of the two rule engines are satisfied, the fifth rule engine is preferentially executed.

In this embodiment of the present disclosure, the priority of the rule engine may be set by the central control end, or may be set by the distributed end, and is carried in the rule engine for reporting. For example, when reporting the first rule engine, the first distributed end reports the priority of the first rule engine through the actionPriority attribute. The central control end determines the priority of the third rule engine according to the priority of the first rule engine. The priority may be represented by an identifier representing a priority, for example, priority 1, priority 2, etc.

Referring to FIG. 6, an embodiment of the present disclosure further provides a cross-platform device-linkage method, performed by a first distributed end, where the method includes:
Step 21: send a first rule engine to a central control end, where the first rule engine is used to instruct to perform a first action when a first trigger condition is met.

Optionally, the identifier corresponding to the first trigger condition is definite and the identifier corresponding to the first action is indefinite.

Optionally, the method further includes: sending first data corresponding to the first trigger condition to the central control end. Further optionally, the first data corresponding to the first trigger condition is sent to the central control end according to the subscription request from the central control end.

Optionally, the first rule engine further includes a first dependency condition, where the first dependency condition is used by the central control end to determine whether the first rule engine matches another rule engine.

Optionally, the first dependency condition includes at least one of the following: a user identifier, location information, and time information.

Optionally, before the sending the first rule engine to the central control end, the method further includes: receiving a fourth rule engine from the central control end, wherein the fourth rule engine is configured to instruct to perform the first action when the second trigger condition is met, where an identifier of a resource corresponding to the second trigger condition is indefinite, and an identifier of a resource corresponding to the first action is indefinite; and determining the first rule engine according to the fourth rule engine.

Before the first rule engine is determined according to the fourth rule engine, the first distributed end first queries the device according to the fourth rule engine, and if the first distributed end has the device in the fourth rule engine, the first rule engine is determined according to the fourth rule engine.

Optionally, before the sending the first rule engine to the central control end, the method further includes: forming the first rule engine based on the input information of the user on the user interface. In other words, the first distributed end may provide a user interface for a user to input related information of the first rule engine.

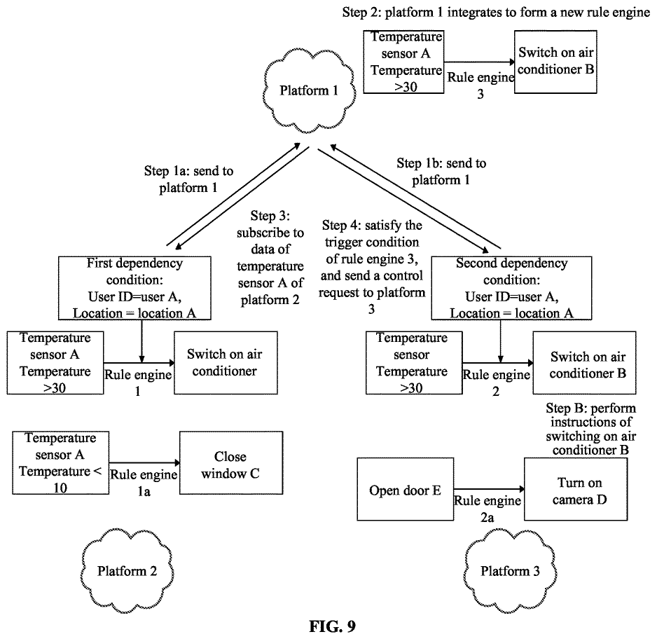

Referring to FIG. 7, an embodiment of the present disclosure further provides a cross-platform device-linkage method, performed by a second distributed end, where the method includes following steps.

Step 31: send a second rule engine to a central control end, where the second rule engine is used to instruct to perform a second action when a second trigger condition is met.

Optionally, an identifier of a resource corresponding to the second trigger condition is indefinite, and an identifier of a resource corresponding to the second action is definite.

Optionally, the second rule engine further includes a second dependency condition, where the second dependency condition is used by the central control end to determine whether the second rule engine matches another rule engine.

Optionally, the second dependency condition includes at least one of the following: a user identifier, location information, and time information.

Optionally, before the sending the second rule engine to the central control end, the method further includes: receiving a fourth rule engine from the central control end, where the fourth rule engine is configured to instruct to perform the first action when the second trigger condition is met, where an identifier of a resource corresponding to the second trigger condition is indefinite, and an identifier of a resource corresponding to the first action is indefinite; and determining the second rule engine according to the fourth rule engine.

Before the second rule engine is determined according to the fourth rule engine, the second distributed end first queries the device according to the fourth rule engine, and if the second distributed end has the device in the fourth rule engine, the second rule engine is determined according to the fourth rule engine.

Optionally, the method further includes: receiving a control request from the central control end and configured to execute the second action, and controlling to execute the second action according to the control request; or receiving first data from the central control end, and controlling, according to the second rule engine, to perform the second action when the first data meets a second trigger condition.

Optionally, before the sending the first rule engine to the central control end, the method further includes: forming the second rule engine according to the input information of the user on the user interface. In other words, the second distributed end may provide a user interface for a user to input related information of the second rule engine.

The cross-platform device-linkage method according to the embodiments of the present disclosure will be described below with reference to specific application scenarios.

In the following embodiments, the platform 1 is the central control end, the platform 2 is the first distributed end, the platform 3 is the second distributed end, the rule engine 1 is the first rule engine, the rule engine 2 is the second rule engine, and the rule engine 3 and the rule engine 3a are the third rule engines.

### Embodiment 1

Referring to FIG. 8, a cross-platform device-linkage method according to an embodiment of the present disclosure includes:
Step 0: the platform 2 and the platform 3 establish connections with the platform 1;
Step 1a: the platform 2 constructs the rule engine 1 and sends the rule engine 1 to the platform 1, and the rule engine 1 is that: when the temperature of the temperature sensor A is greater than 30 degrees, the air conditioner is turned on, wherein the identifier (subjectResourceID) corresponding to the first trigger condition (the temperature is greater than 30 degrees) in the rule engine 1 is definite, and is an identifier of the temperature sensor A, and an identifier (objectResourceID) corresponding to the first action (turning on the air conditioner) is indefinite and is null. In addition, the rule engine 1 further includes a first dependency condition: the user ID=the user A, the location=the location A, specifically, the location A may be a location of the temperature sensor A, or may be a location of the user A. When the location A is the location of the temperature sensor A, the air conditioner B in the rule engine 2 matched with the rule engine 1 can meet the requirement of location A, so that accurate linkage between the temperature sensor A and the air conditioner B can be achieved, and the linkage effect is improved; and when the location A is the location of the user A, the air conditioner B in the rule engine 2 matched with the rule engine 1 can meet the requirement of location A, so that the linkage between the devices in the single home is realized.
Step 1b: the platform 3 constructs the rule engine 2 and sends the rule engine 2 to the platform 1, and the rule engine 2 is that: when the temperature of the temperature sensor is greater than 30 degrees, the air conditioner B is turned on, wherein an identifier (subjectResourceID) corresponding to a second trigger condition (the temperature is greater than 30 degrees) in the rule engine 2 is indefinite, and is null; an identifier (objectResourceID) corresponding to the second action (turning on the air conditioner B) is definite and is an identifier the air conditioner B. In addition, the rule engine 2 further includes a second dependency condition: the user ID=the user A, the location=the location A, specifically, the location A may be the location of the air conditioner B, or may be the location of the user A. When the location A is the location of the air conditioner B, the temperature sensor A in the rule engine 1 matched with the rule engine 2 can meet the requirement of location A, so that accurate linkage between the temperature sensor A and the air conditioner B can be achieved, and the linkage effect is improved; and when the location A is the location of the user A, the temperature sensor A in the rule engine 1 matched with the rule engine 2 can meet the requirement of location A, so that the linkage between the devices in the single user is realized.

The execution of steps 1a and 1b does not have a sequence requirement.
Step 2: the platform 1 determines that the rule engine 1 and the rule engine 2 are matched according to the dependency conditions in the rule engine 1 and the rule engine 2, and then forms a rule engine 3 according to the rule engine 1 and the rule engine 2, where the identifier (subjectResourceID) corresponding to a trigger condition (the temperature is greater than 30 degrees) in the rule engine 3 is definite, and is an identifier of the temperature sensor A; an identifier (objectResourceID) corresponding to the action (turning on the air conditioner B) is definite, and is an identifier of the air conditioner B. Determining whether the rule engine 1 matches with the rule engine 2 by the platform 1 may depend on the dependency conditions. If all or part of the first dependency condition is the same as or equivalent to a corresponding part in the second dependency condition, it is further determined whether the device type corresponding to the subjectResourceID and the objectResourceID in the rule engine 1 matches the device type corresponding to the subjectResourceID and the objectResourceID in the rule engine 2, and if match, it is determined that the rule engine 1 matches the rule engine 2.

When the rule engine 1 and the rule engine 2 do not include a dependency condition, the platform 1 may determine whether the user identifiers corresponding to the rule engine 1 and the rule engine 2 are the same, further determine whether the device type corresponding to the subjectResourceID and the objectResourceID in the rule engine 1 matches the device type corresponding to the subjectResourceID and the objectResourceID in the rule engine 2, and if match, then determines that the rule engine 1 matches the rule engine 2.
Step 3: the platform 1 sends a subscription request for subscribing to the temperature data of the temperature sensor A to the platform 2.
Step 4: the platform 1 receives the temperature data of the temperature sensor A from the platform 2, and sends a control request for controlling turning on the air conditioner B to the platform 3 when the temperature data of the temperature sensor A satisfies the trigger condition in the rule engine 3.
Step 5: the platform 3 controls the air conditioner B to be turned on according to the control request.

### Embodiment 2

Referring to FIG. 9, a cross-platform device-linkage method according to an embodiment of the present disclosure includes:
Step 0: the platform 2 and the platform 3 respectively establish a connection with the platform 1;
Step 1a: the platform 2 constructs a rule engine 1 and an engine rule 1a, and the rule engine 1 is that: when the temperature of the temperature sensor A is greater than 30 degrees, the air conditioner is turned on, wherein the identifier (subjectResourceID) corresponding to the first trigger condition (the temperature is greater than 30 degrees) in the rule engine 1 is definite, and is an identifier of the temperature sensor A, and an identifier (objectResourceID) corresponding to the first action (turning on the air conditioner) is indefinite, and is null. In addition, the rule engine 1 further includes a first dependency condition: the user ID=the user A, the location=the location A. The rule engine 1a is: when the temperature of the temperature sensor A is less than 10 degrees, the window C is closed, wherein the identifier (subjectResourceID) corresponding to the trigger condition (the temperature is less than 10 degrees) in the rule engine 1a is definite, and is an identifier of the temperature sensor A, an identifier (objectResourceID) corresponding to the action (opening window C) is definite, which is the identifier of the window C. That is, the rule engine 1 is an incomplete rule engine, no air conditioning device exists in the platform 2, the air conditioner cannot be controlled to be turned on, the rule engine 1a is a complete rule engine, a window C is arranged in the platform 2, and the window C can be controlled to be closed, so that the platform 2 can execute the rule engine 1a locally and cannot execute the rule engine 1 locally, and then the rule engine 1 is sent to the platform 1
Step 1b: the platform 3 constructs a rule engine 2 and a rule engine 2a. The rule engine 2 is that when the temperature of the temperature sensor is greater than 30 degrees, the air conditioner B is turned on, wherein an identifier (subjectResourceID) corresponding to a second trigger condition (the temperature is greater than 30 degrees) in the rule engine 2 is indefinite and is null; an identifier (objectResourceID) corresponding to the second action (turning on the air conditioner B) is definite and is an identifier of the air conditioner B. In addition, the rule engine 2 further includes a second dependency condition: the user ID=the user A, the location=the location A. The rule engine 2a is: the camera D is turned on when the door is opened, wherein the identifier (subjectResourceID) corresponding to the trigger condition (door E opens) in the rule engine 2a is definite and is the identifier of the door E; the identifier (objectResourceID) corresponding to the action (turning on the camera D) is definite and is the identifier of the camera D. That is, the rule engine 2 is an incomplete rule engine, no temperature sensor exists in the platform 3, it cannot be judged whether the trigger condition is met, the rule engine 2a is a complete rule engine, and a door E and a camera D are arranged in the platform 3, so that the platform 3 can execute the rule engine 2a locally and cannot execute the rule engine 2 locally, and then the rule engine 2 is sent to the platform 1.

The execution sequence of steps 1a and 1b is not specified.
Step 2: The platform 1 determines according to the dependency conditions in the rule engine 1 and the rule engine 2, that the rule engine 1 and the rule engine 2 are matched, and then forms a rule engine 3 according to the rule engine 1 and the rule engine 2, where an identifier (subjectResourceID) corresponding to a trigger condition (the temperature is greater than 30 degrees) in the rule engine 3 is definite and is the identifier of the temperature sensor A, and an identifier (objectResourceID) corresponding to the action (turning on the air conditioner B) is definite, and is an identifier of the air conditioner B.
Step 3: the platform 1 sends a subscription request for subscribing to the temperature data of the temperature sensor A to the platform 2.
Step 4: the platform 1 receives the temperature data of the temperature sensor A from the platform 2, and sends a control request for controlling the turn-on of the air conditioner B to the platform 3 when the temperature data of the temperature sensor A satisfies the trigger condition in the rule engine 3.
Step 5: the platform 3 controls the air conditioner B to be turned on according to the control request.

### Embodiment 3

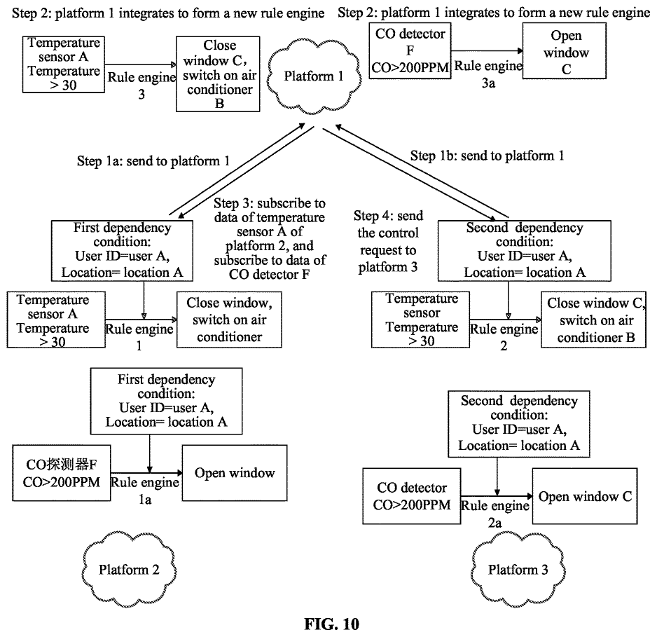

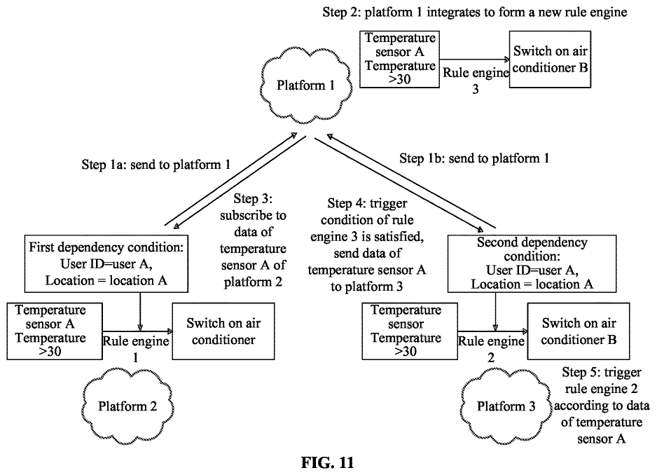

Referring to FIG. 10, a cross-platform device-linkage method according to an embodiment of the present disclosure includes:
Step 0: the platform 2 and the platform 3 respectively establish a connection with the platform 1;
Step 1 a: the platform 2 constructs a rule engine 1 and a rule engine 1a, and the rule engine 1 is that: when the temperature of the temperature sensor A is greater than 30 degrees, the window is closed and the air conditioner is turned on, wherein the identifier (subjectResourceID) corresponding to the trigger condition (the temperature is greater than 30 degrees) in the rule engine 1 is definite, which is an identifier of the temperature sensor A. An identifier (objectResourceID) corresponding to the action (closing the window and turning on the air conditioner) is indefinite and is null. In addition, the rule engine 1 further includes a first dependency condition: the user ID=the user A, the location=the location A. Rule engine 1a is: the window is opened when the CO detected by the CO detector F is greater than 200 PPM, wherein the identifier (subjectResourceID) corresponding to the trigger condition (CO is greater than 200 PPM) in the rule engine 1a is definite, which is an identifier of the CO detector F, and an identifier (objectResourceID) corresponding to the action (opening the window) is indefinite. In addition, the rule engine 1 A further includes a first dependency condition: the user ID=the user A, the location=the location A, that is, the rule engine 1 and the rule engine 1a are incomplete rule engines, and therefore, the platform 2 cannot execute the rule engines 1 and 1a locally, and then sends the rule engines 1 and 1a to the platform 1.
Step 1b: the platform 3 constructs a rule engine 2 and a rule engine 2a. The rule engine 2 is that: when the temperature of the temperature sensor is greater than 30 degrees, the window C is closed and the air conditioner B is turned on, wherein an identifier (subjectResourceID) corresponding to a second trigger condition (the temperature is greater than 30 degrees) in the rule engine 2 is indefinite and is null; an identifier (objectResourceID) corresponding to the second action (close the window C and turn on the air conditioner B) is definite, and are identifiers of window C and the air conditioner B. In addition, the rule engine 2 further includes a second dependency condition: the user ID=the user A, the location=the location A. The rule engine 2a is: the window C is opened when the CO detected by the CO detector is greater than 200 PPM, wherein an identifier (subjectResourceID) corresponding to a trigger condition (CO greater than 200 PPM) in the rule engine 2a is indefinite and is null, and an identifier (objectResourceID) of the action (turning on the window C) is definite and is the identifier of the window C. In addition, the rule engine 1a further includes a first dependency condition: the user ID=the user A, the location=the location A, that is, the rule engine 2 and the rule engine 2a are incomplete rule engines, and therefore, the platform 3 cannot execute the rule engines 2 and 2a locally, and then sends the rule engines 2 and 2a to the platform 1

The execution sequence of steps 1a and 1b is not mandatory.
Step 2: the platform 1 determines that the rule engine 1 and the rule engine 2 are matched according to the dependency conditions in the rule engine 1 and the rule engine 2, and then forms a rule engine 3 according to the rule engine 1 and the rule engine 2, where the identifier (subjectResourceID) corresponding to a trigger condition (the temperature is greater than 30 degrees) in the rule engine 3 is definite, and is an identifier of the temperature sensor A; and an identifier (objectResourceID) corresponding to the action (close the window C and turn on the air conditioner B), which is the identifier of the window C and the identifier of the air conditioner B.

The platform determines that the rule engine 1a and the rule engine 2a are matched according to the dependency conditions in the rule engine 1a and the rule engine 2a, and then form the rule engine 3a according to the rule engine 1a and the rule engine 2a, where the identifier (subjectResourceID) corresponding to a trigger condition (CO is greater than 200 PPM) in the rule engine 3a is definite, which is an identifier of the CO detector F; and an identifier (objectResourceID) corresponding to the action (open the window C) is definite and is an identifier of the window C.

The platform determines the rule engine 3 is related to the rule engine 3a, and may set priorities for the rule engine 3 and the rule engine 3a, for example, the priority of the rule engine 3 is lower than the priority of the rule engine 3a.

The priority may also be set by the platform 2 or the platform 3 and carried in the rule engine and reported to the platform 1.
Step 3: the platform 1 sends, to the platform 2, the subscription request for subscribing to the temperature data of the temperature sensor A and the detection data of the CO detector F.
Step 4: the platform 1 receives the temperature data of the temperature sensor A and the detection data of the CO detector F from the platform 2, and if the temperature data of the temperature sensor A meets the trigger condition in the rule engine 3, meanwhile, the detection data of the CO detector F also meets the trigger condition of the rule engine 3a, and since the priority of the rule engine 3 is lower than the priority of the rule engine 3a, the rule engine 3a is executed, and a control request for controlling the window C to be opened is sent to the platform 3.
Step 5: the platform 3 controls the window C to be opened according to the control request.

### Embodiment 4

Referring to FIG. 11, a cross-platform device-linkage method according to an embodiment of the present disclosure includes:
Step 0 to Step 3: see Embodiment 1.
Step 4: the platform 1 receives the temperature data of the temperature sensor A from the platform 2, and sends the temperature data of the temperature sensor A to the platform 3 when the temperature data of the temperature sensor A satisfies the trigger condition in the rule engine 3.
Step 5: the platform 3 triggers the execution of the rule engine 2 according to the temperature data of the temperature sensor A.

### Embodiment 5

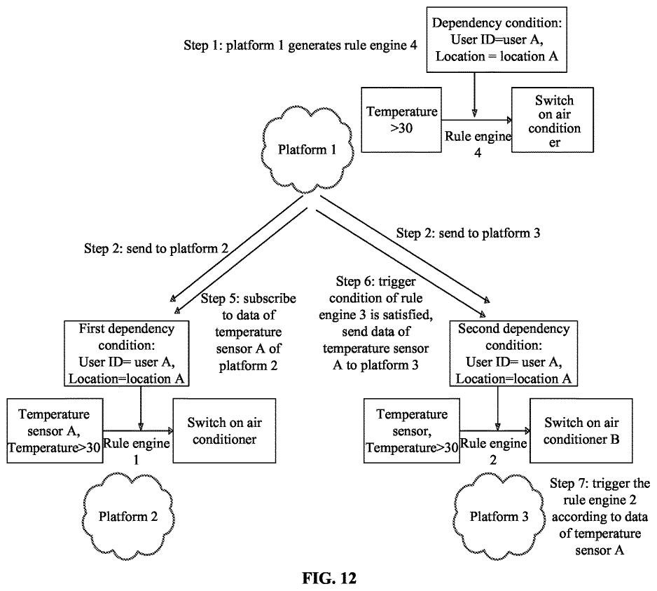

Referring to FIG. 12, a cross-platform device-linkage method according to an embodiment of the present disclosure includes:
Step 0: the platform 2 and the platform 3 respectively establish a connection with the platform 1.
Step 1: the platform 1 constructs a rule engine 4, and the rule engine 4 is that: when the temperature is greater than 30 degrees, the air conditioner is turned on, wherein an identifier (subjectResourceID) corresponding to a trigger condition (the temperature is greater than 30 degrees) in the rule engine 4 is indefinite and is null, and an identifier (objectResourceID) corresponding to an action (turning on the air conditioner) is indefinite and is null. In addition, the rule engine 4 may also include a dependency condition: user ID=user A, location=location A.
Step 2a: platform 1 sends rules engine 4 to platform 2 and platform 3.
Step 3a: the platform 2 retrieves a local device according to the rule engine 4, determines that the local device includes a temperature sensor, constructs the rule engine 1 according to the rule engine 4 and sends the rule engine 1 to the platform 1, and the rule engine 1 is that: when the temperature of the temperature sensor A is greater than 30 degrees, the air conditioner is turned on, wherein the identifier (subjectResourceID) corresponding to the first trigger condition (temperature is higher than 30 degrees) in the rule engine 1 is definite, and is the identifier of the temperature sensor A, and the identifier (objectResourceID) corresponding to the first action (turning on the air conditioner) is indefinite, and is null. In addition, the rule engine 1 may further include a first dependency condition: the user ID=the user A, the location=the location A. when the rule engine 4 includes a dependency condition, and the platform 2 further screens the local device according to the dependency condition, so that the local device meets the dependency condition of the rule engine 4.
Step 3b: the platform 3 retrieves the local device according to the rule engine 4, determines that the local device includes the air conditioner, and then the platform 3 constructs the rule engine 2 according to the rule engine 4 and sends the rule engine 2 to the platform 1, and the rule engine 2 is that when the temperature of the temperature sensor is greater than 30 degrees, the air conditioner B is turned on, wherein the identifier (subjectResourceID) corresponding to the second trigger condition (temperature is higher than 30 degrees) in the rule 2 is indefinite and is null; the identifier (objectResourceID) corresponding to the second action (turning on the air conditioner B) is definite and is the identifier of the air conditioner B. In addition, the rule engine 2 may further include a second dependency condition: the user ID=the user A, the location=the location A. When the rule engine 4 includes a dependency condition, and the platform 3 further screens the local device according to the dependency condition, so that the local device meets the dependency condition of the rule engine 4.

The execution sequence of steps 3a and 3b is not mandatory.
Step 4: the platform 1 determines, according to the dependency conditions in the rule engine 1 and the rule engine 2, that the rule engine 1 and the rule engine 2 are matched, and then forms a rule engine 3 according to the rule engine 1 and the rule engine 2, where the identifier (subjectResourceID) corresponding to the trigger condition (temperature is higher than 30 degrees) in the rule engine 3 is definite and is the identifier of the temperature sensor A, and the identifier (objectResourceID) corresponding to the action (turn on the air conditioner B) and is the identifier of the air conditioner B.
Step 5: the platform 1 sends a subscription request for subscribing to the temperature data of the temperature sensor A to the platform 2.
Step 6: the platform 1 receives the temperature data of the temperature sensor A from the platform 2, and sends the temperature data of the temperature sensor A to the platform 3 when the temperature data of the temperature sensor A satisfies the trigger condition in the rule engine 3.
Step 7: the platform 3 triggers the execution of the rule engine 2 according to the temperature data of the temperature sensor A.

### Embodiment 6

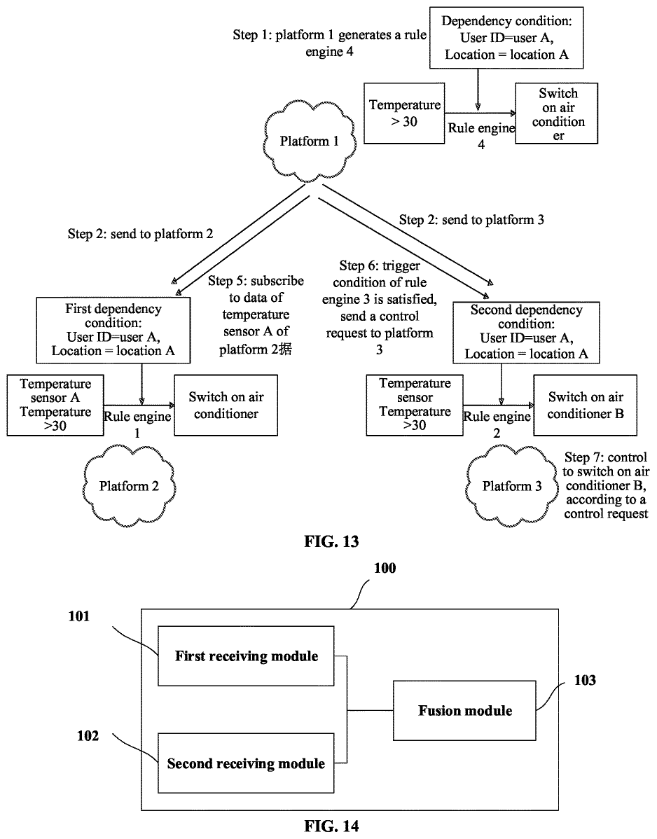

Referring to FIG. 13, a cross-platform device-linkage method according to an embodiment of the present disclosure differs from Embodiment 5 in that:
Step 4: the platform 1 receives the temperature data of the temperature sensor A from the platform 2, and sends a control request for controlling the turn-on of the air conditioner B to the platform 3 when the temperature data of the temperature sensor A satisfies the trigger condition in the rule engine 3.
Step 5: the platform 3 controls the air conditioner B to be turned on according to the control request.

Referring to FIG. 14, an embodiment of the present disclosure further provides a cross-platform device-linkage apparatus 100, including:
a first receiving module 101, configured to receive a first rule engine from a first distributed end, where the first rule engine is configured to instruct to perform a first action in a case that a first trigger condition is met; and a second receiving module 102, configured to receive a second rule engine from a second distributed end, where the second rule engine is configured to instruct to perform a second action in a case that a second trigger condition is met; and a fusion module 103, configured to determine a third rule engine according to the first rule engine and the second rule engine, where the third rule engine is used to indicate that the second action is performed when the first trigger condition is met.

Optionally, the cross-platform device-linkage apparatus 100 further includes: a third receiving module, configured to receive first data corresponding to the first trigger condition from the first distributed end; and a determining module, configured to determine whether the first data meets the first trigger condition; and a triggering module, configured to, if satisfy, trigger the second distributed end to perform the second action.

Optionally, the first rule engine includes a first dependency condition, and the second rule engine includes a second dependency condition; the fusion module 103 is configured to determine whether the first dependency condition matches the second dependency condition; and if match, fuse the first rule engine and the second rule engine to form a third rule engine.

Optionally, the fusion module 103 is configured to: if the identifier corresponding to the first trigger condition is definite and the identifier corresponding to the second trigger condition is indefinite, enable the third rule engine to use the first trigger condition; and if the identifier corresponding to the first action is indefinite and the identifier corresponding to the second action is definite, enable the third rule engine to use the second action.

Optionally, the first dependency condition includes at least one of the following: a user identifier, location information, and time information;

The second dependency condition includes at least one of the following: a user identifier, location information, and time information.

Optionally, the cross-platform device-linkage apparatus 100 further includes: a first sending module, configured to send a subscription request for subscribing to the first data to the first distributed end.

Optionally, the trigger module is configured to send a control request for executing the second action to the second distributed end; or send the first data to the second distributed end to trigger the second distributed end to execute the second action according to the second rule engine.

Optionally, the cross-platform device-linkage apparatus 100 further includes: a construction module, configured to form a fourth rule engine according to input information of a user on a user interface, where the fourth rule engine is configured to instruct to perform the first action when the second trigger condition is met, where an identifier corresponding to the second trigger condition is indefinite, and an identifier corresponding to the first action is indefinite; and a second sending module, configured to send the fourth rule engine to the first distributed end and the second distributed end, so that the first distributed end determines the first rule engine according to the fourth rule engine, and the second distributed end determines the second rule engine according to the fourth rule engine.

Optionally, the trigger module is configured to determine whether a fifth rule engine related to the third rule engine exists, where the fifth rule engine is used to indicate that the third action is triggered when the third trigger condition is met; if the fifth rule engine exists and the third trigger condition is met, determine priorities of the third rule engine and the fifth rule engine; and when the priority of the third rule engine is higher than the priority of the fifth rule engine, trigger the second distributed end to execute the second action.

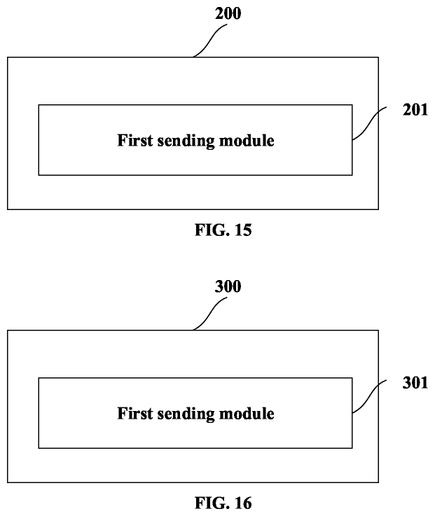

Referring to FIG. 15, an embodiment of the present disclosure further provides a cross-platform device-linkage apparatus 200, including: a first sending module 210, configured to send a first rule engine to a central control end, where the first rule engine is used to instruct to perform a first action when a first trigger condition is met.

Optionally, the identifier corresponding to the first trigger condition is definite and the identifier corresponding to the first action is indefinite.

Optionally, the cross-platform device-linkage apparatus 200 further includes: a second sending module, configured to send the first data corresponding to the first trigger condition to the central control end.

Optionally, the first rule engine further includes a first dependency condition, where the first dependency condition is used by the central control end to determine whether the first rule engine matches another rule engine.

Optionally, the first dependency condition includes at least one of the following: a user identifier, location information, and time information.

Optionally, the cross-platform device-linkage apparatus 200 further includes: a receiving module, configured to receive a fourth rule engine from the central control end, where the fourth rule engine is used to instruct to perform the first action when the second trigger condition is met, where an identifier of a resource corresponding to the second trigger condition is indefinite, and an identifier of a resource corresponding to the first action is indefinite; and a first construction module, configured to determine the first rule engine according to the fourth rule engine.

Optionally, the cross-platform device-linkage apparatus 200 further includes: a second construction module, configured to construct the first rule engine according to the input information of the user on the user interface.

Referring to FIG. 16, an embodiment of the present disclosure further provides a cross-platform device-linkage apparatus 300, including: a first sending module 301, configured to send a second rule engine to a central control end, where the second rule engine is used to indicate to perform a second action when a second trigger condition is met.

Optionally, an identifier of a resource corresponding to the second trigger condition is indefinite, and an identifier of a resource corresponding to the second action is definite.

Optionally, the second rule engine further includes a second dependency condition, where the second dependency condition is used by the central control end to determine whether the second rule engine matches another rule engine.

Optionally, the second dependency condition includes at least one of the following: a user identifier, location information, and time information.

Optionally, the cross-platform device-linkage apparatus 300 further includes: a first receiving module, configured to receive a fourth rule engine from the central control end, where the fourth rule engine is used to instruct to perform the first action when the second trigger condition is met, where an identifier of a resource corresponding to the second trigger condition is indefinite, and an identifier of a resource corresponding to the first action is indefinite; and a first construction module, configured to determine the second rule engine according to the fourth rule engine.

Optionally, the cross-platform device-linkage apparatus 300 further includes: a second receiving module, configured to receive a control request from the central control end and configured to execute the second action; and a first control module, configured to control to execute the second action according to the control request; or a third receiving module, configured to receive first data from the central control end; a second control module, configured to control to execute the second action according to the second rule engine when the first data meets a second trigger condition.

Optionally, the cross-platform device-linkage apparatus 300 further includes: a second construction module, configured to form the second rule engine according to the input information of the user on the user interface.

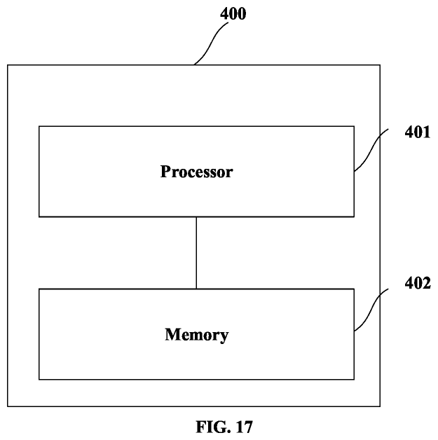

Referring to FIG. 17, an embodiment of the present disclosure further provides an electronic device 400, including a processor 401, a memory 402, and a computer program stored in the memory 402 and executable on the processor 401, where the computer program, when executed by the processor 401, implements various processes of the above-mentioned cross-platform device-linkage method embodiments, and can achieve the same technical effect, which is not repeated here to avoid repetition.

An embodiment of the present disclosure further provides a computer-readable storage medium, where the computer-readable storage medium stores a computer program, and when the computer program is executed by a processor, each process of the above-mentioned cross-platform device-linkage method embodiment is implemented, and the same technical effect can be achieved. The computer-readable storage medium is, for example, a read-only memory (Read-Only Memory, ROM), a Random Access Memory (RAM), a magnetic disk, or an optical disk.

In this embodiment of the present disclosure, by setting a central control end, the central control end is connected to a plurality of distributed ends (vendor platforms), different distributed ends send the rule engines for inter-device linkage to the central control end, and the central control end fuses the rule engines from different distributed ends, so as to generate a rule engine for inter-device linkage of different distributed ends, and implement linkage among devices of different distributed ends.

It should be noted that, in this specification, the terms “include”, “include”, or any other variant thereof are intended to cover non-exclusive inclusion, so that a process, method, article, or apparatus that includes a series of elements includes not only those elements, but also other elements that are not explicitly listed, or elements inherent to the process, method, article, or apparatus. In the absence of more restrictions, elements after the statement “include one” does not exclude there are additional identical elements in the process, method, article, or apparatus that includes the element.

Through the description of the foregoing implementations, a person skilled in the art may clearly understand that the method in the foregoing embodiments may be implemented by means of software plus a necessary general hardware platform, and certainly may also be implemented by hardware, but in many cases, the former is a better implementation. Based on this understanding, the technical solution of the present disclosure essentially or the part contributing to the prior art may be embodied in the form of a software product, and the computer software product is stored in a storage medium (such as a ROM/RAM, a magnetic disk, and an optical disk), and includes a plurality of instructions for enabling a terminal (which may be a mobile phone, a computer, a server, an air conditioner, or a network device) to perform the method according to the embodiments of the present disclosure.

The embodiments of the present disclosure are described above with reference to the accompanying drawings, but the present disclosure is not limited to the specific embodiments described above, and the specific embodiments described above are merely illustrative and not restrictive, and a person of ordinary skill in the art can make many forms without departing from the spirit of the present disclosure and the scope of protection of the claims, and all fall within the protection of the present disclosure.

1. A cross-platform device-linkage method, comprising:
receiving a first rule engine from a first distributed end, wherein the first rule engine is configured to indicate that a first action is performed in a case that a first trigger condition is met;
receiving a second rule engine from a second distributed end, wherein the second rule engine is configured to indicate that a second action is performed in a case that a second trigger condition is met;
determining a third rule engine according to the first rule engine and the second rule engine, wherein the third rule engine is configured to indicate that the second action is performed in a case that the first trigger condition is met.

2. The method according to claim 1, wherein determining the third rule engine according to the first rule engine and the second rule engine further comprises:
receiving first data corresponding to the first trigger condition from the first distributed end; and
determining whether the first data satisfies the first trigger condition;
if satisfying, then triggering the second distributed end to perform the second action.

3. The method according to claim 1, wherein the first rule engine comprises a first dependency condition, and the second rule engine comprises a second dependency condition;
determining the third rule engine according to the first rule engine and the second rule engine includes:
determining whether the first dependency condition matches the second dependency condition; and
if matching, then fusing the first rule engine and the second rule engine to form the third rule engine.

4. The method according to 29. (New) An electronic device, comprising:
a processor, a memory, and a program stored in the memory and executable on the processor, wherein when the program is executed by the processor, the processor implements steps of the cross-platform device-linkage method according to claim 10.
30. An electronic device, comprising:
a processor, a memory, and a program stored in the memory and executable on the processor, wherein when the program is executed by the processor, the processor implements steps of the cross-platform device-linkage method according to claim 17., wherein determining the third rule engine according to the first rule engine and the second rule engine comprises:
if an identifier corresponding to the first trigger condition is definite and an identifier corresponding to the second trigger condition is indefinite, using the first trigger condition of the third rule engine;
if the identifier corresponding to the first action is indefinite and the identifier corresponding to the second action is definite, using the second action for the third rule engine.

5. The method according to claim 3, wherein the first dependency condition comprises at least one of following: a user identifier, location information, and time information;
the second dependency condition comprises at least one of following: a user identifier, location information, and time information.

6. The method according to claim 2, wherein before receiving the first data corresponding to the first trigger condition from the first distributed end, the method further comprises:
sending, to the first distributed end, a subscription request for subscribing to the first data;
or,
triggering the second distributed end to perform the second action comprises:
sending, to the second distributed end, a control request for performing the second action; or
sending the first data to the second distributed end, to trigger the second distributed end to perform the second action according to the second rule engine;
or,
triggering the second distributed end to perform the second action further comprises:
determining whether a fifth rule engine related to the third rule engine exists, wherein the fifth rule engine is used to indicate that a third action is triggered when a third trigger condition is met;
determining priorities of the third rule engine and the fifth rule engine if the fifth rule engine exists and the third trigger condition is met;
when the priority of the third rule engine is higher than the priority of the fifth rule engine, triggering the second distributed end to perform the second action.

7. (canceled)

8. The method according to claim 1, further comprising:
generating a fourth rule engine according to input information of a user on a user interface, wherein the fourth rule engine is used to indicate that the first action is performed when the second trigger condition is met, wherein an identifier corresponding to the second trigger condition is indefinite and an identifier corresponding to the first action is indefinite;
sending the fourth rule engine to the first distributed end and the second distributed end, so that the first distributed end determines the first rule engine according to the fourth rule engine, and the second distributed end determines the second rule engine according to the fourth rule engine.

9. (canceled)

10. A cross-platform device-linkage method, comprising:
sending a first rule engine to a central control end, wherein the first rule engine is used to indicate that a first action is performed when a first trigger condition is met.

11. The method according to claim 10, wherein an identifier corresponding to the first trigger condition is definite and an identifier corresponding to the first action is indefinite;
or,
the method further comprises sending first data corresponding to the first trigger condition to the central control end.

12. (canceled)

13. The method according to claim 10, wherein the first rule engine further comprises a first dependency condition, wherein the first dependency condition is used by the central control end to determine whether the first rule engine matches another rule engine.

14. The method according to claim 13, wherein the first dependency condition comprises at least one of following: a user identifier, location information, and time information.

15. The method according to claim 10, wherein before sending the first rule engine to the central control end, the method further comprises:
receiving a fourth rule engine from the central control end, wherein the fourth rule engine is used to indicates that the first action is performed when a second trigger condition is met, wherein an identifier of a resource corresponding to the second trigger condition is indefinite, and an identifier of a resource corresponding to the first action is indefinite;
determining the first rule engine according to the fourth rule engine;
or,
before the sending the first rule engine to the central control end, the method further comprises: generating the first rule engine according to input information of a user on a user interface.

16. (canceled)

17. A cross-platform device-linkage method, comprising:
sending a second rule engine to a central control end, wherein the second rule engine is configured to indicate that a second action is performed when a second trigger condition is met.

18. The method according to claim 17, wherein an identifier of a resource corresponding to the second trigger condition is indefinite and an identifier of a resource corresponding to the second action is definite.

19. The method according to claim 17, wherein the second rule engine further comprises a second dependency condition, wherein the second dependency condition is used by the central control end to determine whether the second rule engine matches another rule engine.

20. The method according to claim 19, wherein the second dependency condition comprises at least one of following: a user identifier, location information, and time information.

21. The method according to claim 17, wherein before sending the second rule engine to the central control end, the method further comprises:
receive a fourth rule engine from the central control end, wherein the fourth rule engine is configured to indicate that a first action is performed when the second trigger condition is met, wherein an identifier of a resource corresponding to the second trigger condition is indefinite, and an identifier of a resource corresponding to the first action is indefinite;
determining the second rule engine according to the fourth rule engine;
or,
the method further comprises:
receiving, from the central control end, a control request configured to perform the second action; controlling, according to the control request, to perform the second action; or receiving first data from the central control end; controlling, according to the second rule engine, to perform the second action when the first data meets a second trigger condition;
or,
before the sending the first rule engine to the central control end, the method further comprises: generating the second rule engine according to input information of a user on a user interface.

22-26. (canceled)

27. An electronic device, comprising:
a processor, a memory, and a program stored in the memory and executable on the processor, wherein when the program is executed by the processor, the processor implements steps of the cross-platform device-linkage method according to claim 1.

28. (canceled)

29. An electronic device, comprising:
a processor, a memory, and a program stored in the memory and executable on the processor, wherein when the program is executed by the processor, the processor implements steps of the cross-platform device-linkage method according to claim 10.

30. An electronic device, comprising:
a processor, a memory, and a program stored in the memory and executable on the processor, wherein when the program is executed by the processor, the processor implements steps of the cross-platform device-linkage method according to claim 17.
